(19) United States
(12) Patent Application Publication
(10) Pub. No.: US 2025/0018840 A1
(43) Pub. Date: Jan. 16, 2025

(54) RELEASE STRAP POSITION RETENTION SYSTEM

(71) Applicant: Brose Fahrzeugteile SE & Co. Kommanditgesellschaft, Coburg, Coburg (DE)

(72) Inventor: Mohinuddin Shaik, Troy, MI (US)

(73) Assignee: Brose Fahrzeugteile SE & Co. Kommanditgesellschaft, Coburg (DE)

(21) Appl. No.: 18/221,647

(22) Filed: Jul. 13, 2023

(51) Int. Cl. B60N 2/20

(52) U.S. Cl. CPC B60N 2/20

(57) ABSTRACT

A release strap position retention system is disclosed. The release strap position retention system comprises a release strap operatively connected to a recliner and a bezel defining an inner slot for guiding the release strap therethrough. The release strap position retention system also comprises a first flexible cantilever affixed to a first side of the inner slot and a second flexible cantilever affixed to a second side of the inner slot. The first flexible cantilever and the second flexible cantilever are configured to create a friction fit between the flexible cantilevers and the release strap to hold the release strap in a position above the inner slot of the bezel exposing an indicator on a portion of the release strap when the recliner is in an unlocked state that permits movement of the recliner. The indicator denotes to the user that the recliner is in the unlocked state.

### TECHNICAL FIELD

The present disclosure relates to a seat assembly for an automotive vehicle, more particularly to a system for holding a position of a release strap of the seat assembly.

### BACKGROUND

Automotive vehicles include seat assemblies having a recliner to pivotally move a seat back from a seated position to a stowed position. A release strap may be used to allow a user to actuate the recliner of the seat assembly. A loop may be formed on an end of the release strap so that a user may grasp the release strap and actuate the recliner.

### SUMMARY

An aspect of the disclosed embodiments includes a release strap position retention system. The release strap position retention system comprises: a release strap operatively connected to a recliner; a bezel defining an inner slot for guiding the release strap therethrough; a first flexible cantilever affixed to a first side of the inner slot; and a second flexible cantilever affixed to a second side of the inner slot. The first flexible cantilever and the second flexible cantilever are configured to create a friction fit between the first flexible cantilever and the second flexible cantilever and the release strap to hold the release strap in a position above the inner slot of the bezel when the recliner is in an unlocked state that permits movement of the recliner.

Another aspect of the disclosed embodiments includes a seat assembly. The seat assembly comprises: a backrest; a seat cushion assembly; a recliner operatively connected to the seat cushion assembly and configured to change between a locked state, in which the backrest is fixed with respect to the seat cushion assembly, and an unlocked state in which the backrest is movable with respect to the seat cushion assembly; a release strap operatively connected to the recliner; a bezel fixed to at least one of the backrest and the seat cushion assembly configured to receive the release strap; a first flexible cantilever affixed to a first side of an inner slot of the bezel; and a second flexible cantilever affixed to a second side of the inner slot of the bezel. The first flexible cantilever and the second flexible cantilever are adapted to hold the release strap in a position above the inner slot of the bezel exposing an indicator on a portion of the release strap, the indicator denoting that the recliner is in the unlocked state.

Another aspect of the disclosed embodiments includes a release strap position retention system. The release strap position retention system comprises: a release strap operatively connected to a recliner; a bezel defining an inner slot for guiding the release strap therethrough; a first flexible cantilever affixed to a first side of the inner slot; a second flexible cantilever affixed to a second side of the inner slot; a third flexible cantilever affixed to the first side of the inner slot; and a fourth flexible cantilever affixed to the second side of the inner slot. The first flexible cantilever, the second flexible cantilever, the third flexible cantilever, and the fourth flexible cantilever are configured to create a friction fit between the first, second, third, and fourth flexible cantilevers and the release strap to hold the release strap in a position above the inner slot of the bezel when the recliner is in an unlocked state that permits movement of the recliner.

### BRIEF DESCRIPTION OF TIE DRAWINGS

FIG. 1 generally illustrates a seat assembly of a passenger compartment of a vehicle, in accordance with an embodiment.

FIG. 2A provides a close-up front-side perspective view of a release strap guided through an inner slot of a bezel, in accordance with an embodiment.

FIG. 2B provides a close-up side perspective view of a release strap guided through an inner slot of a bezel, in accordance with an embodiment.

FIG. 3A depicts a top-down perspective view of a release strap position retention system, in accordance with an embodiment.

FIG. 3B depicts a bottom-up perspective view of a release strap position retention system, in accordance with an embodiment.

FIG. 3C illustrates a release strap positioned in a release strap position retention system, in accordance with an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

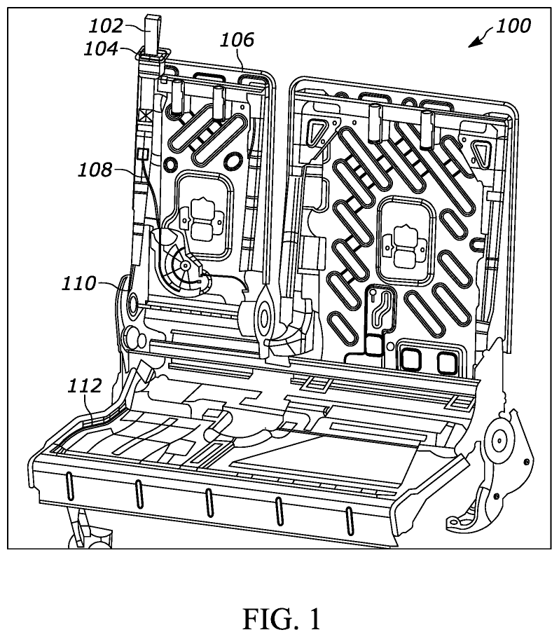

FIG. 1 generally illustrates a seat assembly of a passenger compartment of a vehicle. In FIG. 1, a seat assembly is generally indicated at 100. In embodiments, seat assembly 100 may be located in a front row seating, a second row seating, or a third row seating of the vehicle. As shown in FIG. 1, seat assembly 100 includes a seat cushion assembly 112, a backrest 106 that is mounted and pivotally positioned with respect to seat cushion assembly 112, and a recliner 110 that is operatively connected to seat cushion assembly 112. As further shown in FIG. 1, seat assembly 100 also includes a release strap 102, which is operatively connected to recliner 110, and a bezel 104, which is fixed to backrest 106 and configured to receive release strap 102. In embodiments, bezel 104 may be fixed to at least one of backrest 106 and seat cushion assembly 112.

Recliner 110 may be configured to change between a locked state in which backrest 106 is fixed with respect to seat cushion assembly 112 (i.e., prohibiting movement of backrest 106 and/or seat cushion assembly 112), and an unlocked state in which backrest 106 is movable with respect to seat cushion assembly 112 (i.e., permitting movement of backrest 106 and/or seat cushion assembly 112). More specifically, recliner 110 may be configured to pivotally move backrest 106 from a seated position to a stowed position. For example, this functionality enables a user of the vehicle to create more cargo space or transport longer or larger items.

Furthermore, release strap 102 is configured to allow a user to actuate recliner 110 of seat assembly 100. In some embodiments, a loop may be formed on an end of release strap 102 so that a user may grasp release strap 102 and actuate recliner 110. For example, as depicted in FIG. 1, release strap 102 is operatively connected to recliner 110 via a cable 108. In some embodiments, a user may pull release strap 102 connected to cable 108 to actuate recliner 110.

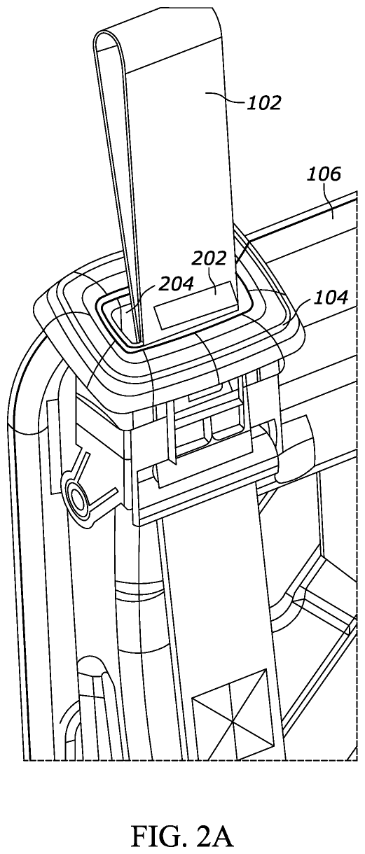

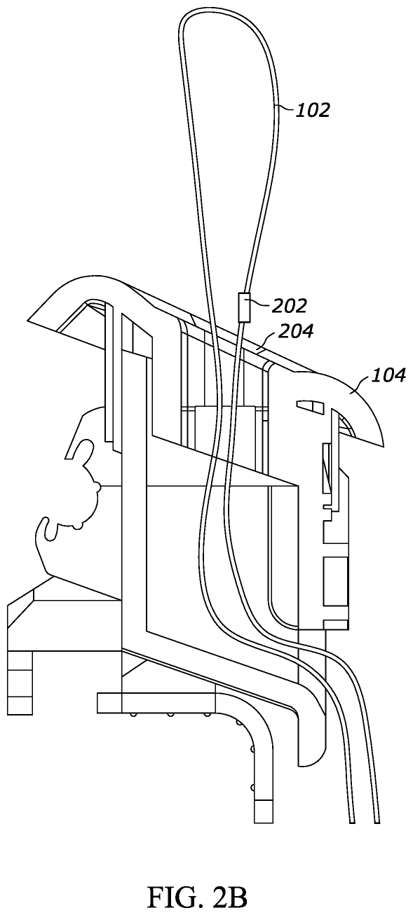

FIGS. 2A and 2B illustrate different close-up perspective views of bezel 104 and release strap 102. FIG. 2A provides a front-side perspective view of bezel 104 and release strap 102, and FIG. 2B provides a side perspective view of bezel 104 and release strap 102. As shown in FIG. 2A, bezel 104 is fixed to backrest 106 and includes an inner slot 204 adapted to guide the release strap 102 therethrough. In this exemplary embodiment, a loop is formed on an end of release strap 102. In other embodiments, an exposed end of release strap 102 may terminate with a strap end cap.

As further shown in 2A and 2B, release strap includes an indicator 202 on a portion of release strap 102. Indicator 202, when exposed or positioned above inner slot 204 of bezel 104, denotes that recliner 110 is in the unlocked state. In contrast, when recliner 110 is in a locked state, indicator 202 is positioned inside inner slot 204 of bezel 104, thereby concealing indicator 202.

In some embodiments, indicator 202 may be sewn on release strap 102. In some embodiments, a glue or a fusible bonding tape may be used to attach indicator 202 to release strap 102. In this exemplary embodiment, indicator 202 is shown to assume a rectangular shape. In other embodiments, indicator 202 may assume any other shape (e.g., square, circle, etc.,), include a color (e.g., red, yellow, orange etc.,), or possess particular qualities (e.g., reflective) so as long as indicator 202 is conspicuous to a user when recliner 110 is in the unlocked state.

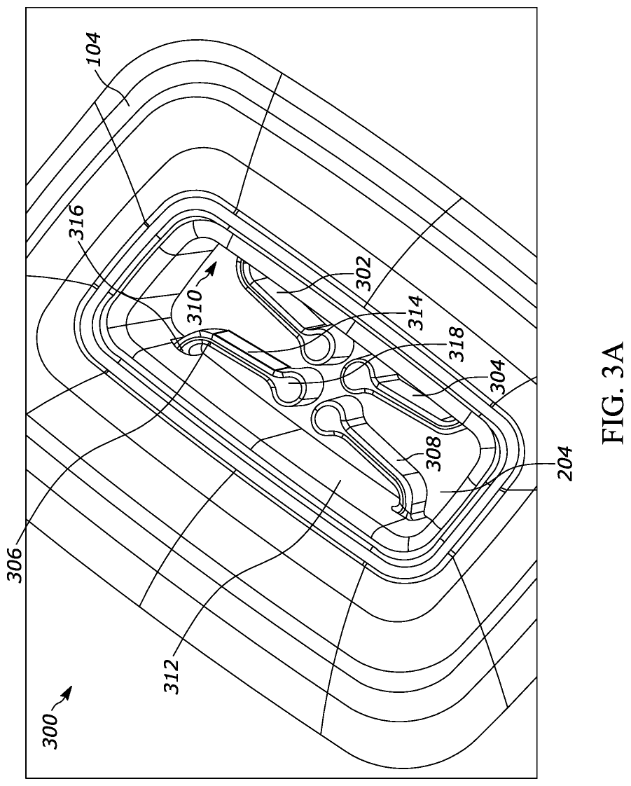

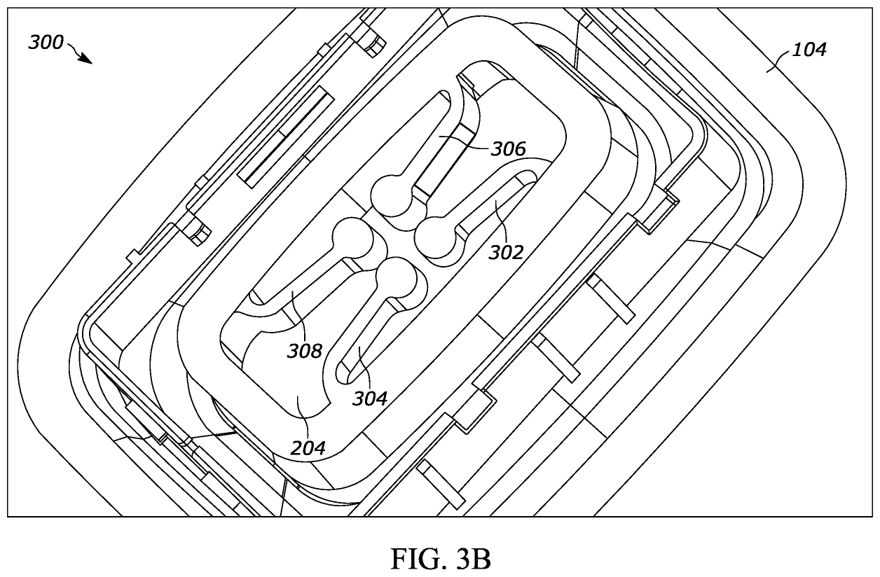

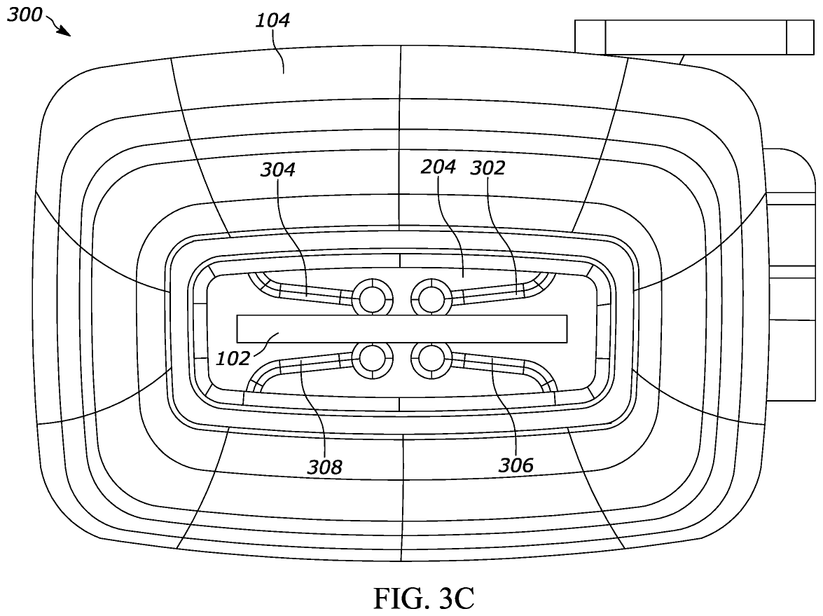

To assist in positioning of release strap 102 within bezel 104 a release strap position retention system is implemented. FIGS. 3A and 3B illustrate different perspective views of an exemplary embodiment of release strap position retention system. More specifically, FIG. 3A provides a top-down perspective of release strap position retention system 300, and FIG. 3B provides a bottom-up perspective of release strap position retention system 300.

In FIGS. 3A and 3B, a release strap position retention system is generally indicated at 300. As shown in FIGS. 3A and 3B, release strap position retention system 300 includes a flexible cantilever 302 and a flexible cantilever 304 affixed to a first side 310 of inner slot 204 and a flexible cantilever 306 and a flexible cantilever 308 affixed to a second side 312 of inner slot 204, where first side 310 is opposite second side 312. As further depicted in FIGS. 3A and 3B, flexible cantilevers 302, 304, 306, and 308 include a main body, a distal end, where the distal end is wider than the main body, and a proximal end, where the proximal end hinges from first side 310 or second side 312. For example, in FIG. 3A, flexible cantilever 306 includes a main body 314, a distal end 318, where distal end 318 is wider than main body 314, and a proximal end 316, where proximal end 316 hinges from second side 312. In this exemplary embodiment, distal end 318 is circular or rounded. However, in some embodiments, distal end 318 may assume other shapes, such as squared, rectangular, etc.

FIG. 3C illustrates release strap 102 positioned between flexible cantilevers 302, 304, 306, and 308 of release strap position retention system 300. Release strap position retention system 300 is configured to engage with release strap 102. For example, flexible cantilever 302 and flexible cantilever 306 are spaced at a suitable distance apart to create an interference fit between the flexible cantilevers and release strap 102. Similarly, flexible cantilever 304 and flexible cantilever 308 are spaced at a suitable distance apart to create an interference fit between the flexible cantilevers and release strap 102. In other words, when release strap 102 passes between flexible cantilevers 302, 304, 306, and 308, release strap 102 makes contact with flexible cantilevers 302, 304, 306, and 308 in a manner sufficient to generate an interference fit. The interference fit resists any force tending to pull release strap 102 further down into bezel 104 (e.g., the weight of cable 108 in FIG. 1) when recliner 110 is in the unlocked state. More specifically, in some embodiments, flexible cantilevers 302, 304, 306, and 308 are configured to hold release strap 102 in a position above inner slot 204 of bezel 104 such that indicator 202 is exposed to a user when recliner 110 is in an unlocked state.

In some embodiments, flexible cantilevers 302, 304, 306, and 308 are configured to allow release strap 102 to slide through inner slot 204 when recliner is in a locked state, thereby concealing indicator 202. For example, flexible cantilever 302 and flexible cantilever 306 may flex in towards first side 310 and second side 312, respectively, (or spring back) to dislodge the interference fit between the flexible cantilevers and release strap 102. Similarly, flexible cantilever 304 and flexible cantilever 308 may flex in towards first side 310 and second side 312, respectively, (or spring back) to dislodge the interference fit between the flexible cantilevers and release strap 102. In some embodiments, flexible cantilevers 302, 304, 306, and 308 may be made of one or more materials, such as a polycarbonate material.

FIGS. 3A-3C depict an exemplary embodiment of release strap position retention system 300 that includes four flexible cantilevers 302, 304, 306, and 308. However, in some embodiments, release strap position retention system may include any number of flexible cantilevers. As one example, in some embodiments, release strap position retention system 300 may include two flexible cantilevers affixed to opposite sides of inner slot 204 of bezel 104.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A release strap position retention system, comprising:
a release strap operatively connected to a recliner;
a bezel defining an inner slot for guiding the release strap therethrough;
a first flexible cantilever affixed to a first side of the inner slot; and
a second flexible cantilever affixed to a second side of the inner slot;
wherein the first flexible cantilever and the second flexible cantilever are configured to create a friction fit between the first flexible cantilever and the second flexible cantilever and the release strap to hold the release strap in a position above the inner slot of the bezel when the recliner is in an unlocked state that permits movement of the recliner.

2. The release strap position retention system of claim 1, wherein the first flexible cantilever is configured to flex in towards the first side and the second flexible cantilever is configured to flex in towards the second side to allow the release strap to slide through the inner slot when the recliner is in a locked state that prohibits movement of the recliner.

3. The release strap position retention system of claim 1, wherein the first flexible cantilever is opposite the second flexible cantilever.

4. The release strap position retention system of claim 1, wherein the first flexible cantilever has a main body and a distal end, the distal end being wider than the main body.

5. The release strap position retention system of claim 4, wherein the first flexible cantilever further includes a proximal end, the proximal end hinging from the first side.

6. The release strap position retention system of claim 1, wherein the second flexible cantilever has a main body and a distal end, the distal end being wider than the main body.

7. The release strap position retention system of claim 6, wherein the second flexible cantilever further includes a proximal end, the proximal end hinging from the second side.

8. The release strap position retention system of claim 1, further comprising:
a third flexible cantilever affixed to the first side of the inner slot; and
a fourth flexible cantilever affixed to the second side of the inner slot, wherein the third flexible cantilever and the fourth flexible cantilever are configured to hold the release strap in the position above the inner slot of the bezel when the recliner is in the unlocked state.

9. The release strap position retention system of claim 8, wherein the third flexible cantilever is opposite the fourth flexible cantilever.

10. The release strap position retention system of claim 8, wherein the third flexible cantilever is configured to flex in towards the first side and the fourth flexible cantilever is configured to flex in towards the second side to allow the release strap to slide through the inner slot when the recliner is in a locked state that prohibits movement of the recliner.

11. A seat assembly, comprising:
a backrest;
a seat cushion assembly;
a recliner operatively connected to the seat cushion assembly and configured to change between a locked state, in which the backrest is fixed with respect to the seat cushion assembly, and an unlocked state in which the backrest is movable with respect to the seat cushion assembly;
a release strap operatively connected to the recliner;
a bezel fixed to at least one of the backrest and the seat cushion assembly configured to receive the release strap;
a first flexible cantilever affixed to a first side of an inner slot of the bezel; and
a second flexible cantilever affixed to a second side of the inner slot of the bezel, wherein the first flexible cantilever and the second flexible cantilever are adapted to hold the release strap in a position above the inner slot of the bezel exposing an indicator on a portion of the release strap, the indicator denoting that the recliner is in the unlocked state.

12. The seat assembly of claim 11, wherein the first flexible cantilever and the second flexible cantilever are adapted to allow the release strap to slide through the inner slot of the bezel concealing the indicator when the recliner is in the locked state.

13. The seat assembly of claim 11, wherein the first flexible cantilever is opposite the second flexible cantilever.

14. The seat assembly of claim 11, wherein the first flexible cantilever has a main body and a distal end, the distal end being wider than the main body.

15. The seat assembly of claim 14, wherein the first flexible cantilever further includes a proximal end, the proximal end hinging from the first side.

16. The seat assembly of claim 11, wherein the second flexible cantilever has a main body and a distal end, the distal end being wider than the main body.

17. The seat assembly of claim 16, wherein the second flexible cantilever further includes a proximal end, the proximal end hinging from the second side.

18. A release strap position retention system, comprising:
a release strap operatively connected to a recliner;
a bezel defining an inner slot for guiding the release strap therethrough;
a first flexible cantilever affixed to a first side of the inner slot;
a second flexible cantilever affixed to a second side of the inner slot;
a third flexible cantilever affixed to the first side of the inner slot; and
a fourth flexible cantilever affixed to the second side of the inner slot,
wherein the first flexible cantilever, the second flexible cantilever, the third flexible cantilever, and the fourth flexible cantilever are configured to create a friction fit between the first, second, third, and fourth flexible cantilevers and the release strap to hold the release strap in a position above the inner slot of the bezel when the recliner is in an unlocked state that permits movement of the recliner.

19. The release strap position retention system of claim 18, wherein the first flexible cantilever and the third flexible cantilever are configured to flex in towards the first side and the second flexible cantilever and the fourth flexible cantilever are configured to flex in towards the second side to allow the release strap to slide through the inner slot when the recliner is in a locked state that prohibits movement of the recliner.

20. The release strap position retention system of claim 18, wherein the first side is opposite the second side.
